(19) United States
(12) Patent Application Publication
(10) Pub. No.: US 2008/0288406 A1
(43) Pub. Date: Nov. 20, 2008

(54) System and method for telematic marketing

(75) Inventors: Pierre Robert Emile Seguin, Toronto (CA); Doug Thompson, Toronto (CA); Scott James Duffy, Toronto (CA); George Haddad, Mississauga (CA)

Correspondence Address: X-PATENTS, APC, 5670 LA JOLLA BLVD., LA JOLLA, CA, 92037, US

(73) Assignee: The Marketing Store Worldwide LLC

(21) Appl. No.: 11/804,188

(22) Filed: May 16, 2007

(51) Int. Cl. G06Q 30/00

(52) U.S. Cl. 705/50; 705/10; 705/14

(57) ABSTRACT

A method and system is provided for delivering promotional offers, information, or entertainment content relevant to a person comprising tracking the travel patterns, using the person's travel patterns to identify goods, services information or content of potential interest to the person, determining the location of the person and delivering relevant offers, information or content to that person based on the collected information. Various embodiments of the present invention use information from diverse sources to deliver highly relevant, timely promotional offers, information, or entertainment content to users via on-board processing and storage systems.

### BACKGROUND OF THE INVENTION

1. Field of the Invention

The invention relates generally to the field of telematics. In particular, the invention relates to a method and system for marketing goods and services using telematics.

2. Description of Related Art

The term telematics generally refers to the integration of telecommunications and information processing systems. More recently the term is often used to refer specifically to the integration of wireless communications, vehicle monitoring systems, and location devices to provide services to motor vehicles or motor vehicle fleet management systems. Such systems may also be referred to as vehicle telematics. While the invention here is described largely in terms of a system used with motor vehicles such as passenger cars, it is in no way limited to such systems and may be applied using almost any mobile device, including without limitation mobile phones, personal digital assistants, handheld navigation devices, etc.

Prior art telematics applications include concierge services, navigation systems, integration systems for personal digital assistants and cell phones, fleet tracking systems, remote diagnostics systems, television and internet access, satellite radio, and location-based services implemented in cell phones and other portable devices. These various telematics systems have been implemented both as original equipment and as after-market products.

These prior art systems, however, are limited in their ability to securely deliver highly relevant, real-time information to users as the user moves through different locations without the need for a continuous network connection. These prior art systems also fail to provide a flexible system for marketing that allows advertisers to reach the best possible prospects as close to the decision point as possible. Prior art systems also fail to provide an effective means for response tracking, allowing additional flexibility in development and monitoring of marketing campaigns.

### SUMMARY OF THE INVENTION

A method and system are provided that deliver promotional offers and other information and content to users in their vehicle or via a mobile device based on information regarding the user. An exemplary method according to the invention is a method for delivering promotional offers, information, or entertainment content relevant to a person. The travel patterns of the person are tracked and used to identify goods, services, information, or entertainment content of potential interest to said person. The person's location is also determined and the relevant materials are delivered to the person for redemption at a location convenient to the person's current location.

In other more detailed features of the invention, the method also includes determination of the location of the person based on the location of a vehicle. In other more detailed features of the invention, the method also includes delivery of offers that are based on said person's location at the time the offer is delivered. In other more detailed features of the invention, the method also includes determining the condition of said person's vehicle. In other more detailed features of the invention, the method also includes delivery of offers that are related to the condition of said person's vehicle.

In other more detailed features of the invention, the method also includes determining the time of day, day of week, season, temperature, or other environmental conditions at said person's location. In other more detailed features of the invention, the method also includes delivery of offers that are delivered to a specific location in said person's vehicle depending on the intended recipient.

An exemplary embodiment of the invention is a method for delivering promotional offers, information, or entertainment content relevant to a person. The location of the person is determined and the person's destination or travel route is identified. The person is provided promotional offers, information, or entertainment content at said destination or along said travel route.

In other more detailed features of the invention, the method also includes determination of the person's location based on the location of a vehicle. In other more detailed features of the invention, the method also includes provision of offers, information, or entertainment content that are based on said user's location at the time the offer is delivered. In other more detailed features of the invention, the method also includes offers, information, or entertainment content that are based on said user's past locations or travel route. In other more detailed features of the invention, the method also includes identifying said person's current mental and physiological state and provision of offers, information, or entertainment content that are based on said person's mental or physiological state.

In other more detailed features of the invention, the method also includes provision of offers, information, or entertainment content that are based on the user's profile as provided to the system independently of location or vehicle data. In other more detailed features of the invention, the method also includes provision of offers, information, or entertainment content are based on user's prior responses to system prompts. In other more detailed features of the invention, the method also includes provision of offers, information, or entertainment content are tagged with appropriate logic to determine the prior patterns and current conditions that must be in place for delivery.

An exemplary embodiment of the invention is a method for delivering promotional offers, information, or entertainment content relevant to a person. Confidentially collected, stored and processed information relevant to content delivery is stored on a local storage medium. This information is processed on a local processor and transmitted to a central processor for aggregation and use in content delivery. In other more detailed features of the invention, the method also includes storage of the information in encrypted form. In other more detailed features of the invention, the method also includes delivery of the content to the user's local system in advance. In other more detailed features of the invention, the method also includes storing said content locally on the user's system until it is used.

### BRIEF DESCRIPTION OF THE DRAWINGS

FIG. 1 is an illustration of an exemplary telematic marketing system.

FIG. 2 is an illustration of an exemplary architecture for a telematic marketing system.

FIG. 3 is a block diagram of an exemplary telematic marketing system.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

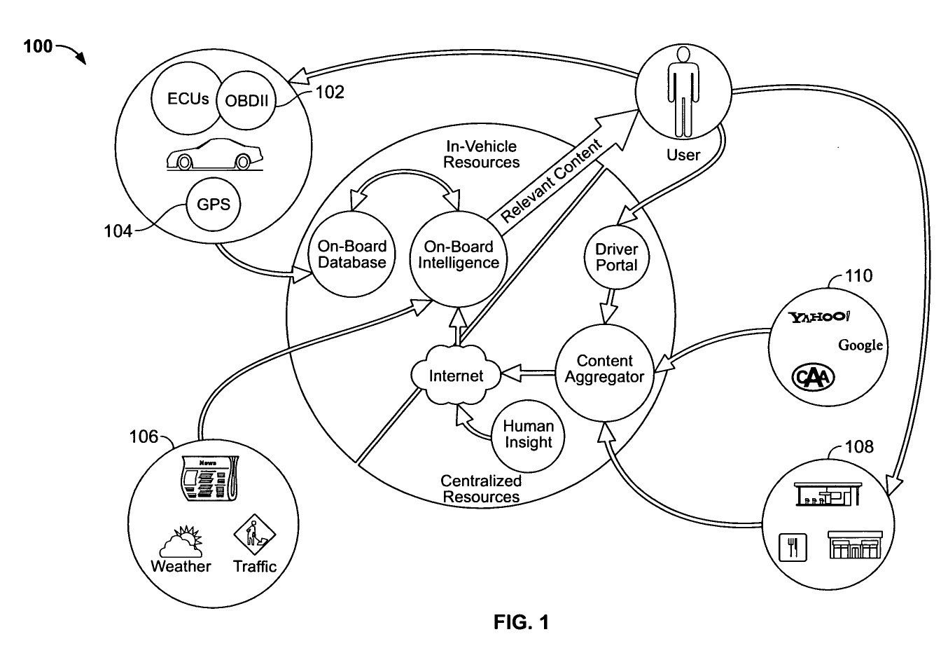

Referring to FIG. 1, the telematic marketing system 100 according to the present invention aggregates consumer data from a variety of sources to provide highly relevant, real-time marketing information to consumers. Sources of information may include vehicle on-board computer systems 102, global positioning system (GPS), or other positioning system based navigation devices 104, traffic monitoring systems 106, real-time data feeds 108, information content providers 110, as well as virtually any other source of relevant information regarding a consumer. Other examples of relevant inputs include calculated variables such as the time, date and season, public databases such as white pages, yellow pages and NAVTEQ, as well as historical information regarding responses to prior offers.

These various sources of information provide detailed input data such as information regarding the driver of the vehicle, number of passengers present in the vehicle, vehicle make and model, vehicle location, vehicle speed and direction, traffic and construction in the area, local services, weather conditions, biometrics, vehicle environment, etc. Information from these various sources is then aggregated and used to provide highly relevant marketing information or content to users.

### Overview of the System

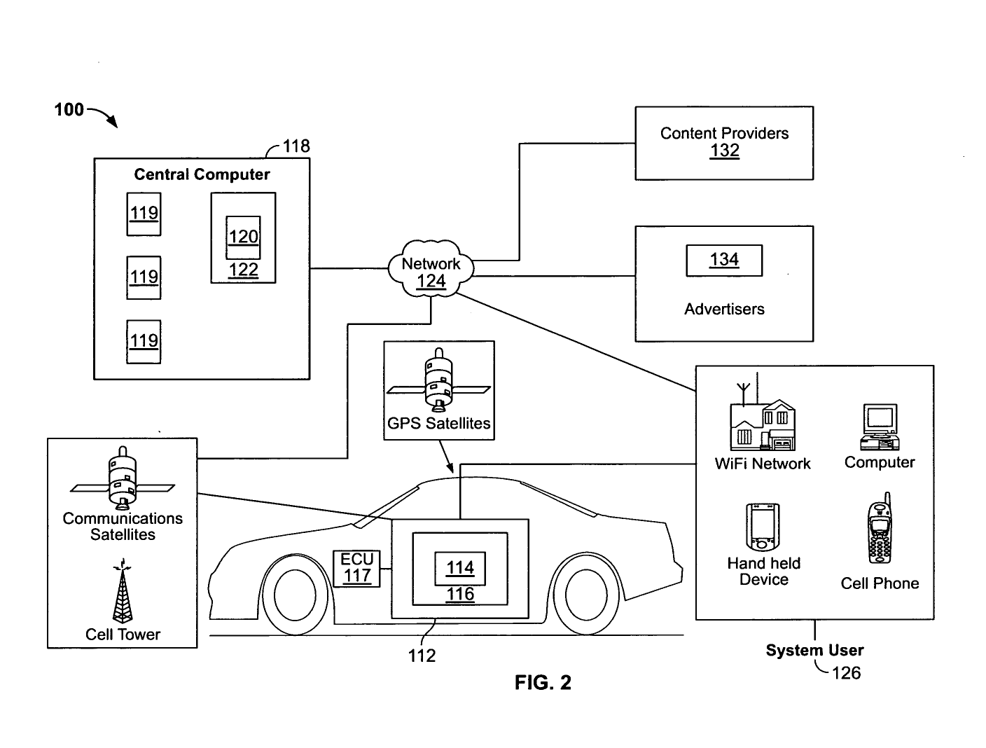

Referring to FIG. 2, in one embodiment the telematic marketing system 100 of this invention includes a secure on-board computer 112 that includes an on-board database 114 containing relevant information about the consumer and potential marketing information. The on-board database is stored on a first recording medium 116 on the on-board computer 112. The system also includes an on-board software application stored in a first recording medium 116 on the on-board computer 112.

The telematic marketing system 100 also has central computer 118 that may include one or more servers. A central database 120 contains a variety of consumer information stored on a second recording medium 122 on said central computer 118. The system also includes a central software application stored in a second recording medium 122 on said central computer 118.

The on-board computer 112 and central computer 118 are connected to each other via a network 124, such as the Internet. It will be understood by those of ordinary skill in the art that the various computers described herein can take many different forms, such as a personal computer, workstation, personal digital assistant, cellular or other mobile phone processor, television, audio player, or any other digital device that can store data and access a network in whatever form it may take in the future. Similarly, the term server as used herein refers broadly to a class of computers in use today, but also encompasses any form of digital storage and processing device that may fulfill the same role in a networked environment. These and other references to contemporary digital devices are used by way of example rather than limitation, and are to be construed broadly to encompass technological developments.

The system 100 aggregates data from a variety of sources, including without limitation the vehicle driver or system user 126, the vehicle itself and its on-board computer systems 128, real-time data feeds 130, third-party content providers such as web sites 132, and a database of available marketing promotions 134.

In one embodiment, the on-board database 114 is automatically updated and synchronized with the central database 120 on a periodic basis, such as once-per-day. Updates may be provided using a standard wireless network connection, such as a standard home WiFi network (802.11x), via a mobile phone or personal digital assistant synchronization, or by any other appropriate connection protocol. Updates can be provided at any appropriate interval, or may be continuous if system functionality allows. The on-board database may be continuously or periodically updated with data from any onboard systems. Vehicle based systems may be provided as part of the original equipment from the manufacturer or as aftermarket products that can be installed in currently operating vehicles.

### Driver Data

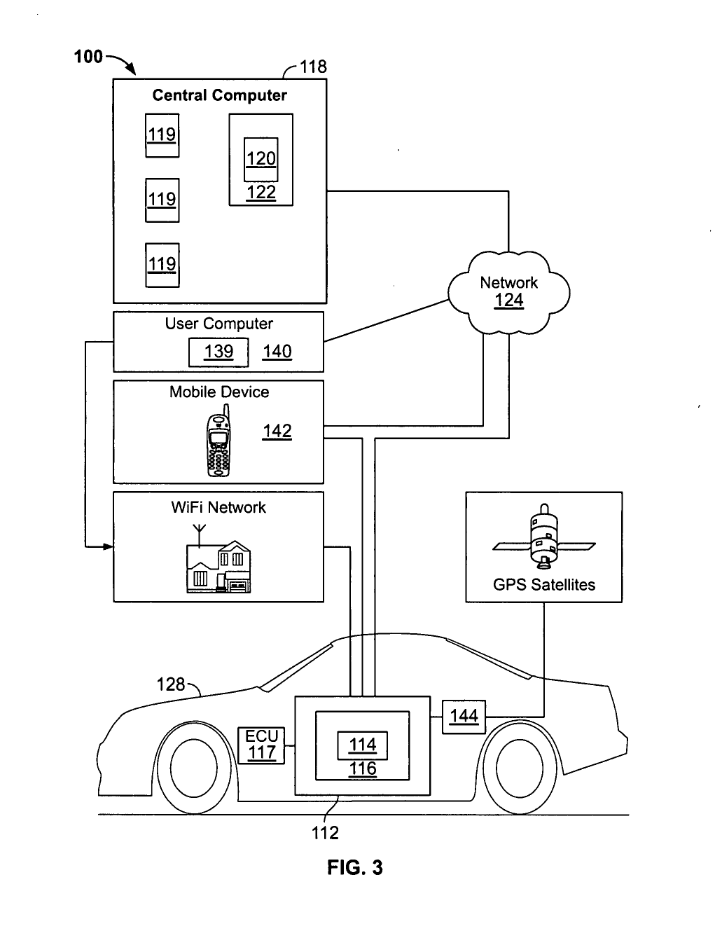

The driver of the vehicle or other user of the present invention may provide information about themselves, their vehicles, other vehicle occupants, or virtually any other topic directly to the system 100. In one embodiment illustrated in FIG. 3, users typically access the system 100 via the central computer 120 through a client software application installed on the user's computer 140, although the system can also be configured to provide access via a web-based application or by any other available input system, including handheld computers and other mobile devices.

In one embodiment of the invention, the user establishes a user profile to provide specific guidance regarding that user's preferences. The system may require certain basic information such as name, postal code, and vehicle make, model and year. The user may also input relevant data about their background and interests, or any other topic that can be used to help filter and target relevant information and marketing offers. The user may also indicate what types of content he or she is interested in receiving while using the system. Preferences may also include customer-activated modes (dining, entertainment, work, travel) that can alter the content displayed according to driver preferences.

For example, if the user indicates that he or she is a vegetarian, the system may present offers for vegetarian restaurants, while filtering offers relating to steakhouses. This filtering and targeting may be performed by the system indirectly based on general information provided by the user, or it may be based on specific preferences expressed by the user such as particular favorite restaurants, stores, or activities.

### Vehicle Data

Modern motor vehicles are equipped with a variety of on-board systems that provide a variety of potentially useful information about vehicle and occupant status. These commonly include engine control systems, transmission control systems, safety systems for managing onboard components such as air bags, ABS, tire pressure monitors, etc., and may include far more sophisticated and detailed data.

At a minimum, all vehicles manufactured after January 1996 have a standard interface to engine data known as the On Board Diagnostic System or OBD-II. OBD-II uses sensors in the vehicle to provide the engine control unit (ECU) with information about the status of various systems and vehicle operations. The ECU uses this information to manage the emissions and fuel economy of the engine. Sensors throughout the vehicle monitor everything from the coolant temperature to the amount of oxygen in the exhaust. The OBD-II system stores the data and the ECU may use real-time data to make adjustments to current operations to enhance performance, improve gas mileage, reduce emissions, etc. The system also tests the various sensors in the vehicle and illuminates a warning light for the driver when a signal is missing or outside of expected parameters. Information from the OBD-II memory can be accessed via a connector in the vehicle.

Many vehicles also have proprietary systems that gather and store a wide variety of additional information beyond the standard diagnostic information provided by the OBD-II system. These systems may provide real-time monitoring of virtually any vehicle system, such as number of passengers, tire pressure, fluid levels, fuel level, periodic maintenance status. More advanced systems can provide extensive, detailed information about the vehicle, its occupants, and local conditions including: (1) interior/exterior temperature, atmospheric pressure, humidity, etc.; (2) window, convertible top, or sunroof open/closed status; (3) identity of the driver based on smart memory key fobs or RFID transponders that automatically adjust the seat and mirrors when the driver approaches; (4) interior settings such as seat recline status, climate control setting, steering wheel angle; (5) driving style indications such as acceleration (Gs), pitch/yaw/roll; (6) ride height and traction conditions; (7) time of day, date, season; (8) ambient light levels; (9) color preferences; (10) connected devices (ipod, cell phone, PDA); (11) currently-selected gear, driving mode; (12) vehicle load (inferred from calculated engine load %, transmission temperature, suspension ride height); (13) music volume, tone settings; and (14) currently-selected radio station.

Vehicles could also be equipped with non-intrusive biofeedback monitoring equipment (such as conductive steering wheel grip points) to monitor various types of biometric information such as pulse, body temperature, skin pH, etc., for all vehicle occupants to provide indications of stress, drowsiness, hunger, etc.

Many vehicles are also equipped with navigation systems that are commonly used for vehicle tracking and navigation. Commercial navigation systems for vehicles are widely available and provide detailed real-time information about the precise location of the vehicle, direction and speed of travel. Finally, general information about the vehicle itself, such as make, model, year, color, customization, etc. may also be gathered to provide indications about the driver's behavior.

All of this data can be stored to either the on-board or central computer for use by the system, although storage to the on-board system may be preferred in many situations. Because the system requires only periodic updates to the on-board computer, when the data is stored on-board the system does not require continuous network connectivity. The on-board computer is owned by the owner of the vehicle, and does not transmit any historical or real-time data regarding the user or the vehicle to the central computer unless the user opts to make such a transmission. The data stored on the on-board computer can be highly encrypted, thus providing significantly enhanced data privacy and security. This configuration also allows the system to provide full functionality even if network communications are limited or unavailable.

### Informational Content

In one embodiment, the system can retrieve data from virtually any source of informational content either on a continuous or periodic basis. Examples of content sources include Internet portals such as GOOGLE or YAHOO, digital news services, RSS feed sources including specialized types of feeds such as podcasts, and digital content providers of all types. The user may also be able to use their user profile to specify particular content to be downloaded or provide information that can be used to target relevant content.

In one embodiment, highly time-sensitive information, such as traffic, weather or road conditions, is fed to the on-board computer continuously, even while the vehicle is in motion. Using current technology, this can be done via standard WiFi connections, cellular networks, or satellite channels, depending on the available communications infrastructure.

### Marketing Partners

In one embodiment of the invention, entities that want to deliver content to users of the system buy access from the system operator. Advertisers provide data regarding their products or services, targeting parameters for specific offers to users, and the terms and conditions for any offers or promotions. Advertisers can use XML-based web services to publish data to the system, or use any other compatible form that can be recognized by the system. Preferably, the format will allow advertising on the system to be integrated into the existing information technology infrastructure of the advertiser.

The system may be controlled by a variety of input/output devices, including without limitation keyboards, touchscreens, joysticks, trackballs, click-wheels, voice recognition and synthesis, audio messaging, heads-up displays, etc. Content may be managed using virtually any convenient menu and navigation system, many examples of which are known to those of ordinary skill in the art. Content may be delivered by one or a combination of means, such as an initial audio message such as a chime, display of the message on a navigation screen visible to one or more users, and a synthesized voice message describing the offer. The user may be provided with controls that set preferences for message delivery. For location-based content, the screen may also display navigational information including maps and directions to the relevant location.

In one embodiment, the system uses targeting algorithms to identify relevant content for delivery to specific users. The on-board system uses available data from all sources to identify content that is relevant to the user at that particular time based on a wide variety of factors. Examples of system operations can range from the simple to very complex, and may include logic that tunes the system to improve conversion rates based on feedback regarding offers that are successful.

In a first example, the system recognizes that a particular vehicle frequently stops for thirty (30) minutes or more at a dog park, and also frequently stops near known pet store locations. When the vehicle passes a particular pet store, the system may inform the user that the vehicle is near that store and provides an offer for a discount on dog food from that location.

In another example, a vehicle has been driving non-stop for four (4) hours at night. As the vehicle approaches a service area or freeway exit, the system presents the user with an offer for gas, food, or other services. In this example, the offer may be specific to a store that is at that service area or near the exit, or it may be specific to a store that is at the next service area or freeway exit a short distance further down the road. Thus, offers can be used to prompt a user to travel some distance further to the particular store targeting the user.

In another example, the system may receive data indicating that the vehicle engine is running slightly hotter than normal. This temperature difference may not be hot enough to trigger a dashboard warning signal, but may accelerate the degradation of vehicle coolant and lubricants. The system may inform the user of the situation and present an offer for oil and coolant servicing, either from a nearby service provider or from a particular service provider of the user's choice. Thus, targeting of the offers may be either location dependent, or location independent.

In another example, a minivan driver has provided information via the system's web portal indicating that he or she has children. The minivan's usual route stops at a known school for several minutes each weekday in the morning and again in the afternoon. After the vehicle stops near the school in the afternoon, the system may infer that there are children in the vehicle and present an offer for age-appropriate products or route a targeted, rich-media video advertisement to the back-seat video monitor.

In another example, a driver in a vehicle on a highway with a posted speed limit of 65 MPH is traveling at an average speed of less than 15 MPH between the hours of 4 pm and 7 pm on a weekday. Biometric sensors in the steering wheel read an elevated driver heart rate. The system will infer that the driver is experiencing stress in rush hour traffic, fade in soft music through the sound system and provide an offer for a spa or vacation resort.

In another example, a vehicle is driving on a road during mid-December in an area that experiences winter conditions. The ambient temperature is near freezing, and the vehicle's traction control and ABS features have been activated several times since the vehicle last stopped. The system would deliver a marketing message offering winter tires.

Targeting of information may also be trip-based where there is sufficient data about the intended destination. For example, when a customer has input a destination into a vehicle navigation system, and the navigation system has calculated that the destination is a long distance away (greater than 60 miles), the system can offer the customer a discount on gas or on food at a nearby gas station. When the vehicle is traveling to a known vacation destination (i.e.: Las Vegas, Orlando, Fort Lauderdale) and that destination is not normally part of the customer's daily routine, as determined either by a preprogrammed route plan or current vehicle location as determined by the navigation system, the system can display offers relevant to the driver's needs during vacation.

When a customer has input a destination into the navigation system that is more than a certain distance away and the destination city is not their home city, the system can suggest lodging offers relevant to the destination city. In addition, the system can provide hotel phone numbers so that a hotel can be booked en route, or with wireless network connectivity the system could automatically book a hotel reservation following a positive response to a targeted prompt.

Information may be highly location and event specific. For example, when the vehicle is traveling in a city or county that has a local festival going on at that time (ie: Montreal during the Jazz Festival, Oakville during the Autumn Harvest Festival, Toronto during the CNE, New Orleans during the Mardi Gras, etc) the system can display information and offers relevant to those events. For instance, the system can display the names and locations of various venues, schedules of events, and background information on the performers.

When the vehicle is within a set distance of a specific business, and the system detects the car is being parked, the system can display offers from that business. For instance, the system can display any offers for SEARS when the customer is parked within a set distance from a SEARS store. As an alternative, when the vehicle is within a set distance of a specific business and the system detects the car is being parked, the system can display offers from a competitor to that business. For instance, when the customer is parked within set distance from a SEARS store, the system can display offers from a competing retailer. The user may then divert to the competitor, or may spend less money or nothing at all, if they are convinced that prices are lower at the competitor just before they go into SEARS.

The system can also be used to promote sales of additional products. For example, if the car is parked at a known gas station, the system can suggest add-on products or services for that retailer or offer a discount on windshield-wipers, a car wash or a cold drink. Such offers may require immediate redemption in order to promote up-sell during a particular visit. In another similar example, if the vehicle is currently entering the perimeter of an airport in or near the customer's home city, the system can display offers for long-term vehicle parking.

The system can also self-tune its delivery of offers to avoid a negative experience or to avoid providing discounts or promotional offers when they are not necessary to induce consumer activity. For example, when the customer parks for 30 minutes or more outside a known religious establishment (church or temple) on a regular basis, the system can display fewer offers for certain classes of products (ie: casinos, bars, etc.) If a user regularly shops at a particular store, the system may determine that promotions are not necessary and may suppress the display of particular offers. Similarly, when the customer is driving past 10:00 pm local time, the system could display only offers for 24-hour or late-night stores and suppress offers for stores that do not have late-night operations.

When the customer has identified their gender using the online web site, the system can display more offers for certain classes of gender-specific products (ie: make-up, department stores, hair salons, and shoe stores for women; home depot, computer stores, and fast food restaurants for men). When the customer has identified their make and model of vehicle using the online web site, the system can display more offers for certain classes of products based on the known demographic profiles of those car owners. For instance, customers driving Infiniti vehicles will be given more luxury offers (jewelry stores, travel, spas, high-end electronics, etc.) while customers that drive sports cars (the Nissan Z) will be given offers aimed at a younger demographic. When the customer has also provided their age using the online web site, the system can display more offers for certain classes of products based on the known demographic profiles of those car owners. For instance, drivers over the age of 63 who drive a certain class of vehicles (Infiniti, Lexus, Cadillac) can be assumed to be retired, and can see offers relating to retirement (real estate, timeshares, travel, etc.).

Offers may also be based on category patterns. For example, the system can track a customer's food preferences through patterns. If a customer is known to park for 45 minutes to 2 hours outside of Chinese food restaurants, the system can display offers for other Chinese restaurants the customer has not visited yet based on the assumption that the user enjoys Chinese food. The assumption is the system can learn the customer's food preferences. The system can also track what type of food the customer ate within the last week and display options for alternatives on the assumption that some users enjoy variety. The system can also generally track the frequency a customer eats out at restaurants, so a customer who eats out two or more times a week can get food offers more often than a customer who rarely eats out.

A variety of other types of add-on offers may be provided by the system. For example, if the system has been across the Canadian or Mexican border for an extended period of time (say, more than 48 hours), the system can display customs shopping limits (ie: $100 for 48 hours, $500 for one week) as a free service, or combined with an offer from a duty-free store. If the vehicle is currently parked, and is currently within range of an open WiFi access point, the system can offer free web browsing or email checking. If the vehicle is currently parked, and is currently within range of an open WiFi access point, the system can offer free VOIP long distance telephone calls within the United States. Digital content associated with a particular service can also be offered.

### Offer Delivery and User Interface

The system can deliver offers in a variety of ways. In one embodiment, the offer is sent as a coupon delivered to the user's mobile device. By way of example, such a coupon may appear as a bar code on the screen that can be scanned at the point of sale, it could include a code that can be transmitted to a receiver at the point of sale by a wireless protocol such as Bluetooth, or it could be password that the user provides or inputs into a device at the point of sale. In one embodiment, the on-board computer can transmit the offer to another system, such as the user's email account or text message the information to a mobile device.

In one embodiment, the system includes transaction processing capabilities so that the user can automatically redeem the offer through the system. For purchases, when the user arrives at the store, the transaction has already been processed so the user can simply pick up the items and leave. Such a system may include a “BUY NOW” or similar button that would enable one-touch transactions using stored payment information to simplify the process and provide for safer transactions when the vehicle is in motion. Similar transaction processing can set reservations for dining, lodging, or other activities.

If an offer is redeemed, the coupon codes or other tracking information allows the central system to be automatically informed of the transaction. Such redemption information can be used to track effectiveness, or it can be used to establish billing that is based directly on response rates or revenue generated.

The system can also be used as part of a customer loyalty program that provides rewards for redemption of offers. This would allow the system to gain access to users through established marketing programs that have an existing base of clients and advertisers.

one embodiment, the system includes a feedback system that allows some or all users to provide input into the system regarding their reactions to particular offers or promotions. This feedback system could allow responses such as Yes/No/Later, or touch a color band that fades from blue to red in order for the system to gauge a variable level of “warmth” or receptiveness to a given offer.

User prompts may be formal or informal. For example, when the vehicle is traveling on a major highway at less than 20 miles per hour and approaching an exit, the system can display an offer to the driver about a nearby shopping mall or major retail location. For example, the system can actually word the offer conversationally, using language such as “Why don't you take a break from this bad traffic? Get off at the next exit and go to Fairview Mall. The traffic will likely be better in an hour.”

Use of XML or similar protocols allows advertisers or their agencies to define and transmit to central server information regarding products and promotion delivery, such as: (1) product description; product category; (2) promotion parameters (price, price off, percentage off, expiry time/date, etc.); (3) consumer patterns that would suggest interest in the offering; (4) parameters for identification of the patterns of interest; (5) real-time triggers required for the offering (e.g. time of day, location, heading, vehicle data, etc.); or (6) informational content sponsored by the product.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

What is claimed is:

1. A method for delivering promotional offers, information, or entertainment content relevant to a person, comprising:
tracking the travel patterns of said person;
using said travel patterns to identify goods, services, information, or entertainment content of potential interest to said person;
determining said person's location;
delivering a promotional offer for said identified goods, services, information or entertainment content to said person that can be redeemed at a location convenient to said person's location.

2. The method of claim 1, wherein the location of said person is determined based on the location of a vehicle.

3. The method of claim 1, wherein said offers are based on said person's location at the time the offer is delivered.

4. The method of claim 1, further comprising determining the condition of said person's vehicle.

5. The method of claim 4, wherein said offers are related to the condition of said person's vehicle.

6. The method of claim 1, further comprising determining the time of day, day of week, season, temperature, or other environmental conditions at said person's location.

7. The method of claim 1, wherein said offers are delivered to a specific location in said person's vehicle depending on the intended recipient.

8. A method for identifying promotional offers, information, or entertainment content relevant to a person, comprising:
determining said person's location;
identifying said person's destination or travel route;
providing promotional offers, information, or entertainment content at said destination or along said travel route.

9. The method of claim 8, wherein the location of said person is determined based on the location of a vehicle.

10. The method of claim 8, wherein said offers, information, or entertainment content are based on said user's location at the time the offer is delivered.

11. The method of claim 8, wherein said offers, information, or entertainment content are based on said user's past locations or travel route.

12. The method of claim 8, further comprising identifying said person's current mental and physiological state.

13. The method of claim 12, wherein said offers, information, or entertainment content are based on said person's mental or physiological state.

14. The method of claim 8, wherein said offers, information, or entertainment content are based on the user's profile as provided to the system independently of location or vehicle data.

15. The method of claim 8, wherein said offers, information, or entertainment content are based on user's prior responses to system prompts.

16. The method of claim 8, wherein said offers, information, or entertainment content are tagged with appropriate logic to determine the prior patterns and current conditions that must be in place for delivery.

17. A method for confidentially collecting, storing and processing information relevant to content delivery, comprising:
storing information relevant to content delivery on a local storage medium;
processing said information on a local processor;
transmitting said information to a central processor for aggregation;
aggregating said information for use in content delivery.

18. The method of claim 17, wherein said information is stored in encrypted form.

19. The method of claim 17, wherein said content is delivered to the user's local system in advance.

20. The method of claim 17, further comprising storing said content locally on the user's system until it is used.
